(19) United States
(12) Patent Application Publication
(10) Pub. No.: US 2011/0268083 A1
(43) Pub. Date: Nov. 3, 2011

(54) METHOD TRANSFERRING VOICE CALLS

(75) Inventors: Peter Ostrup, Linkoping (SE); Paul Schliwa-Bertling, Ljungsbro (SE); Anders Molander, Linkoping (SE)

(73) Assignee: TELEFONAKTIEBOLAGET LM ERICSSON (PUBL), Stockholm (SE)

(21) Appl. No.: 12/521,507

(22) PCT Filed: Jun. 7, 2007
(86) PCT No.: PCT/SE2007/050406

§ 371 Date: Jun. 26, 2009

(30) Foreign Application Priority Data
Dec. 27, 2006 (SE) 0602824-5

(51) Int. Cl. H04W 4/00

(52) U.S. Cl. 370/331

(57) ABSTRACT

In a method and system for transferring a voice call in the packet switched domain to a system supporting both packet switched and circuit switched voice calls, target system, i.e. the system to which an ongoing voice call is transferred is in control of deciding if an ongoing voice call in the originating system should continue in the circuit switched domain or the packet switched domain. In addition the system is enabled to reserve resources in the system to receive the voice call before handing over the voice call.

### TECHNICAL FIELD

The present invention relates to a method and a device for transferring a voice call from one radio telecommunication system to another telecommunication system.

### BACKGROUND

Today a number of different standards for cellular telecommunication exist. Examples of such standards include: Global System for Mobile Communication (GSM). Code Division Multiple Access (CDMA), and Wideband Code Division Multiple Access (WCDMA) among others. In the future other telecommunication system will develop such as Long Term Evolution (LTE).

All these standards may exist side by side or even overlapping within an area served by an operator. The operator of such a combined network of different standards is faced with the problem of having to manage the resources within the combined network in a way that both maximizes the use of the combined resources and maximizes the service provided to each mobile user within the combined network.

Furthermore, many of the more recent standards are only using packet switched technologies as a data transport mechanism including transport of voice calls. Other systems such as GSM sometimes use circuit switched connections for voice calls.

Under such circumstances where a number of different radio networks interact it is inevitable that an existing packet switched voice call will be transferred into a circuit switched voice call for one of a number of different reasons. One such reason could be that the call has to be transferred from a system supporting packet switched voice calls to a system not supporting packet switched voice calls. Other scenarios also exist. For example it might prove beneficial to transfer a packet switched call to a circuit switched call in order to maximize use of available radio resources.

One way of accomplishing such a voice call transfer from being packet switched to being circuit switched could be to disconnect the packet switched voice call connection and then establish a corresponding circuit switched voice call connection. However, such an approach would likely involve an unacceptably long interruption in the service to the user. It is reasonable to expect that with such an approach it would at least take 4 to 5 seconds for the voice call to be transferred during which time period the call has to be interrupted. Such long interruption times are unacceptable for most users.

Hence, there exist a need for a method and a system that is able to make a voice call connection transition from a packed switched voice call connection to a circuit switched voice call connection that is fast and can provide a transition in a time frame that is acceptable for more users. In addition such a method and system should invoke as little changes as possible to existing systems in order to decrease the cost for updating and maintaining such existing systems.

### SUMMARY

It is an object of the present invention to overcome or at least reduce some of the problems associated with the transfer of a packed switched voice call connection to a circuit switched voice call connection.

It is another object of the present invention to provide a method and a device that is capable of transferring a packed switched voice call connection to a circuit switched voice call connection in a short time.

It is yet another object of the present invention to provide a method and a device that is capable of transferring a packed switched voice call connection to a circuit switched voice call connection and which involves little or no change in existing systems thereby making it cheap and easy to implement.

These objects and others are obtained by the method and system as set out in the appended claims. Thus, by letting target system, i.e. the system to which an ongoing voice call is transferred be in control of deciding if an ongoing voice call in the originating system should continue in the circuit switched domain or the packet switched domain a reduction in transfer time can be accomplished. In addition the target system is enabled to reserve resources in the system to receive the voice call before handing over the voice call.

The advantages of this solution include the possibility to make a transfer from the packet switched domain to the circuit switched domain without dual transfer mode (DTM) support but with an estimated interruption time of around only 2 seconds or less. Furthermore the solution will require no or small changes in existing radio systems making it inexpensive to implement.

In a preferred embodiment the mobile station is DTM capable and that the network utilizes this capability during a transition to a circuit switched (CS) connection to achieve a 300 ms interruption time or less. The solution does not, however, require support for the DTM feature on the target network side since the resource reservation in itself provides the allocation and assignment of circuit switched and packet switched resources in parallel.

### BRIEF DESCRIPTION OF THE DRAWINGS

The present invention will now be described in more detail by way of non-limiting examples and with reference to the accompanying drawings, in which:

FIG. 1 is a view illustrating a protocol for transferring a voice call between two different systems, and

FIG. 2 is a view of a protocol for combined routing area and location area update.

### DETAILED DESCRIPTION

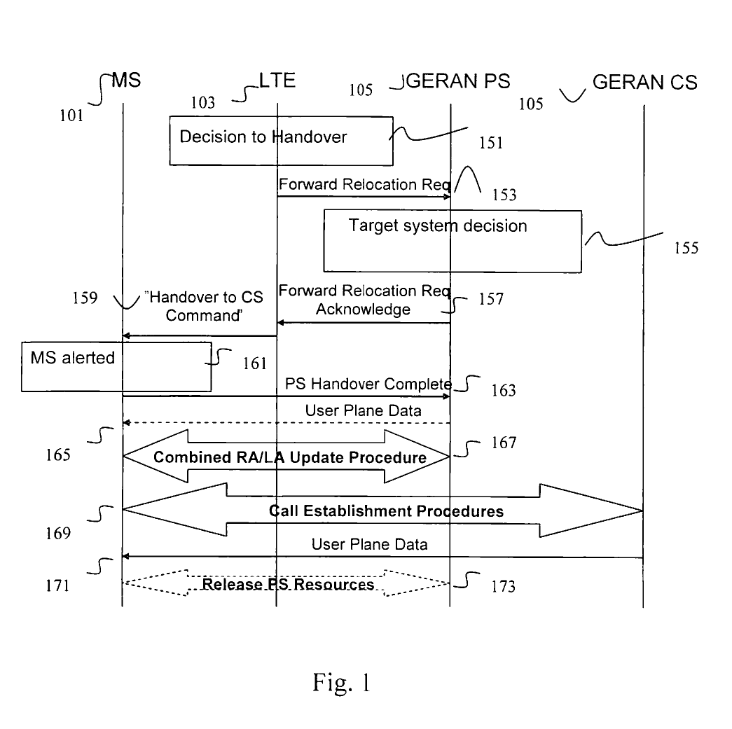

In FIG. 1 a view illustrating a protocol for transferring a voice call between two different systems is shown. Hence, in FIG. 1 a Mobile station (MS) 101 able to communicate to two different cellular radio systems 103 and 105 is depicted. One of the radio systems can for example be a long term extension (LTE) 103 or any other packet switched (PS) radio network. Hence, it is also envisaged that the system 103 can be a GERAN or UTRAN or a similar system. The other radio system 105 can for example be GSM EDGE Radio Access Network (GERAN) or any other system supporting circuit switched (CS) voice calls. The system 105 can also be another system than GERAN supporting circuit switched voice calls such as for example UTRAN.

When a decision to perform a handover of a voice call from the first system 103 to the second system 105 is taken the following steps are carried out in accordance with a preferred embodiment of the present invention. First, in a step 151, a voice call transition decision is taken. The decision could be based on a number of different grounds, one being measurement reports from the Mobile station 101 itself.

Next, as a first step in response to the decision to transfer the call from the system 103 to the system 105 a relocation request 153 is transmitted from the system 103 to the system 105. In response to the request 153 the system receiving the call makes a decision if the call is to continue in the packet switched domain or if it is going to be transferred to the circuit switched domain. The decision regarding which domain the call is to continue in is taken in a step 155 and can depend on a number of different considerations such as the quality of service associated with the call and the capabilities of the cell in which the call is to continue. Also in step 155 resources in the packet switched domain and the circuit switched domain are allocated.

Next the system 105 returns an acknowledgement to the request 153 as a message 157. The message 157 preferably includes information relating to one of the following:
A packet switched Handover Command updated to include also circuit switched resources
A message for Handover to circuit switched Command including both packet switched and circuit switched resources, or
The DTM Handover Command.

The message 157 is the forwarded to the Mobile station 101 as a message 159. When the Mobile station 101 receives the message 159 it will be alerted in a step 161 that the call is to continue in the circuit switched domain because it will receive resources related to the circuit switched domain. In response to the message 159 the Mobile station 101 transmits a message 163 back to the system 105 indicating that the packet switched voice call handover is completed.

If Dual Transfer Mode, i.e. the mobile station can send/receive in both packet switched and circuit switched domain simultaneously, is supported by the mobile station and to some extent by the network, then it is possible to start user plane transfer at this stage. Hence in that scenario, in response to the message 163, the system 105 returns user plane data to the mobile station 101 in a message 165. Thus, if the mobile station supports DTM, it will be able to utilize the PS resources included in the Inter-Domain Handover Command for user plane transfer in parallel with setting up the CS bearer.

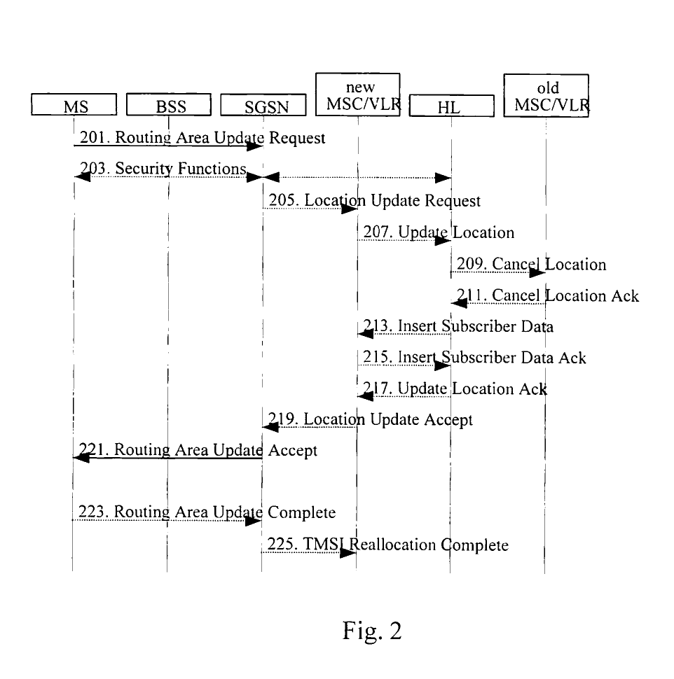

Next, in a step 167 a combined Routing Area (RA)/Location Area (LA) update is performed as described below in conjunction with FIG. 2. Next in a step 169 a call establishment procedure is performed. Preferably Voice call continuity (VCC) as described in 3GPP TS 23.882 is performed during, or after, the call establishment. VCC will re-connect the two calling parties so that the handed-over mobile station is connected through the circuit switched domain and connect with the other party through the IP Multimedia Subsystem (IMS).

Thereupon, in a step 171, user plane data are transferred from the system 105 to the mobile station if this has not already been done. Finally, in a step 173, the packet switched resources are released. If DTM is not supported in MS or network, the release of the packet switched resources would have been performed after the Combined RA/LA Update procedure.

In FIG. 2, the steps performed in the combined RA/LA update are shown. Thus, first in a step 201 the MS sends a Routing Area Update Request to the Serving GPRS Support Node (SGSN). The Update Type will indicate a combined RA/LA update, or, if the MS wants to perform an International Mobile Subscriber Identity (IMSI) attach, a combined RA/LA update with IMSI attach is requested. The Base Station Subsystem (BSS) will then add the Cell Global Identity including the RAC and LAC of the cell where the message was received before passing the message to the SGSN.

Next, in a step 203 security functions may be executed. If the security functions fail (e.g. because the SGSN cannot determine the Home Location Register (HLR) address to establish the Send Authentication Info dialogue), the Inter SGSN RAU Update procedure fails. A reject will then be returned to the MS with an appropriate cause.

Next, if the Update Type indicates combined RA/LA update with IMSI attach requested, or if the LA changed with the routing area update, the SGSN sends a Location Update Request in a message 205 including new LAI, IMSI, SGSN Number, Location Update Type to the Visitor Location Register (VLR). The Location Update Type will indicate IMSI attach if the Update Type in step 201 indicated a combined RA/LA update with IMSI attach requested. Otherwise. Location Update Type will indicate normal location update. When the SGSN does not provide functionality for the Intra Domain Connection of RAN Nodes to Multiple CN Nodes, the VLR number is derived from the RAI. When the SGSN provides functionality for Intra Domain Connection of RAN Nodes to Multiple CN Nodes, the SGSN uses the RAI and a hash value from the IMSI to determine the VLR number. The VLR creates or updates the association with the SGSN by storing the SGSN Number.

Next, if the subscriber data in the VLR is marked as not confirmed by the HLR, the new VLR informs the HLR. The HLR cancels the data in the old VLR and inserts subscriber data in the new VLR. First, in as step. 207 the new VLR sends an Update Location (new VLR) to the HLR. Thereupon, the HLR cancels the data in the old VLR by sending Cancel Location (IMSI) to the old VLR, step 209. In response, the old VLR acknowledges with Cancel Location Ack (IMSI), step 211. The HLR then sends Insert Subscriber Data (IMSI, subscriber data) to the new VLR, step 213, and the new VLR acknowledges with Insert Subscriber Data Ack (IMSI), step 215. Thereupon, the HLR responds with Update Location Ack (IMSI) to the new VLR, step 217, and the new VLR allocates a new VLR TMSI and responds with Location Update Accept (VLR TMSI) to the SGSN. VLR TMSI is optional if the VLR has not changed, step 219.

Next, in a step 221, the SGSN validates the MS's presence in the new RA. If due to regional subscription restrictions the MS is not allowed to be attached in the RA, or if subscription checking fails, the SGSN rejects the routing area update with an appropriate cause. If all checks are successful, the SGSN updates the MS context for the MS. A new P-TMSI may be allocated. The SGSN responds to the MS with Routing Area Update Accept (P-TMSI, VLR TMSI, P-TMSI Signature).

If a new P-TMSI or VLR TMSI was received, the MS confirms the reallocation of the TMSIs by returning a Routing Area Update Complete message to the SGSN, step 223. Finally, the SGSN sends a TMSI Reallocation Complete message to the VLR if the MS confirms the VLR TMSI, step 225.

Hence, the system as described herein will reserve radio resources before the actual channel change is performed. If the target system decides to perform a fallback to the circuit switched domain, the target system will hence in accordance with the invention reserve the circuit switched radio resources together with the packet switched radio resources during the packet switched handover preparation phase of a voice call transfer.

The packet switched handover command message from the source BSS to the mobile station is preferably updated to include a circuit switched radio resource description in parallel with the packet switched radio resource description. In accordance with another preferred embodiment, the DTM handover command can be used to transfer both the packet switched and the circuit switched radio resource descriptions to the mobile station.

The presence of circuit switched radio resources in the packet switched handover command message (or the fact that a DTM Handover Command is received) will indicate to the mobile station that a fallback to the circuit switch domain is taking place and that the call will continue in the circuit switched domain.

During the transition to the circuit switched domain, the mobile station should preferably not use the packet switched radio resources included in the packet switched or DTM handover command for user plane transfer but should instead preferably use them for sending a combined RAU/LAU to update its location in the Core Network (CN).

As an alternative, the packet switched radio resources may be used for user plane transfer during the preparation of the circuit switched bearer. However such an approach would require DTM support in the mobile station.

Thus, the reservation and assignment of CS and PS resources in the target cell makes it possible for a DTM capable mobile station to utilize the assigned CS and PS resources in parallel, in the target cell, after successful cell change. It should be noted that while the CS resources are reserved and assigned in parallel with the PS resources as part of the transfer to CS functionality, there is no requirement on the target network to support the DTM feature. If the target system decides to perform a transition to CS, it should thus reserve the CS radio resources together with the PS radio resources during the PS Handover preparation phase. A message will carry the CS and PS resource descriptions from the target network to the mobile station, this message can for example be included in the Target BSS to Source BSS Transparent Container.

Furthermore, when the Combined RAU/LAU procedure has been completed over the PS radio resources, the mobile station will release the PS resources and will start to establish the circuit switched bearer. Since the circuit switched radio resources are already reserved, the mobile station can perform the normal call establishment procedures over those resources avoiding unnecessary interruption time from radio resource allocation via random access. The voice call is then re-established on the CS bearer using a somewhat modified VCC. see 3GPP TS 23.206. The needed modification of VCC would be to allow for a “break before make” behavior.

The method and system as described herein will provide numerous advantages. For example a voice call handover in accordance with the method and system as described herein will always succeed in terms of resource availability (or fail before any harm is done it should be noted that if there are no resources available in the target cell, the source system can try an alternative cell without any interruptions to speech. If the call is simply terminated and a new call is set up in the new system, the call could be lost while the User Equipment (UE) leaves the source system only to discover that there are no resources in the target cell.

The voice call transfer to the target system will be faster compared to a pure Call Re-establishment solution, and the UE will need not to allocate radio resources through a random access channel before continuing the establishment of a CS bearer, which in turn even further enhances the performance of the voice call transfer in terms of call interruption time.

1. A method of voice call transfer of a mobile station between a first radio system supporting a packet switched voice call connection and a second radio system supporting a circuit switched voice call connection and a packet switched voice call connection, the method comprising:
initiating a transfer of the voice call from the first system to the second system;
in the second system, determine determining if the transferred voice call should continue in the packet switched domain or if the voice call should continue in the circuit switched domain; and
transferring the voice call to the second system in accordance with the determination made in the second system.

2. The method according to claim 1, further comprising:
reserving radio resources in the second system both in the packet switched domain and the circuit switched domain before transferring the voice call.

3. The method according to claim 1, further comprising:
during the voice call transfer, transmitting a message from the first system to the mobile station indicating that circuit switched radio resources have been reserved in the second system.

4. The method according to claim 3, further comprising:
in response to the message indicating a reservation of radio resources in the circuit switched domain, alerting the mobile station that the call will continue in the circuit switched domain.

5. The method according to claim 1, where the mobile station is capable of dual transfer mode (DTM) and
where the method further comprises:
transmitting user plane data as a direct response to the mobile station, the user plane data indicating that packet switched handover is completed.

6. The method according to claim 1, where the mobile station is capable dual transfer mode (DTM) and
where the method further comprises:
using the packet switched radio resources for user plane transfer during preparation of a circuit switched bearer.

7. A radio system node for handling transfer of a voice call of a mobile station between a first radio system supporting a packet switched voice call connection and a second radio system supporting a circuit switched voice call connection and a packet switched voice call connection, the second radio system comprising the radio system node, the radio system node comprising:
means for receiving a transferred voice call; and
means for determining if the transferred voice call should continue in the packet switched domain or if the transferred voice call should continue in the circuit switched domain in response to receiving the transferred voice call.

8. The radio system node according to claim 7, further comprising:
means for reserving radio resources in the second system both in the packet switched domain and the circuit switched domain before transferring the voice call.

9. The radio system node according to claim 7, further comprising:
means alerting the mobile station that the call will continue in the circuit switched domain in response to a message indicating a reservation of radio resources in the circuit switched domain.

10. The radio system node according to claim 7, further comprising:
means for transmitting user plane data as a direct response to the mobile station indicating that packet switched handover is completed.

11. A mobile station capable of dual transfer mode (DTM), the mobile station comprising:
means for receiving an indication that a voice call is being transferred from a packet switched voice call connection to a circuit switched voice call connection; and
means for using packet switched radio resources for user plane transfer during preparation of a circuit switched bearer and during a voice call transfer between a first radio system supporting a packet switched voice call connection and a second radio system supporting a circuit switched voice call connection and a packet switched voice call connection.
